(19) United States
(12) Patent Application Publication
(10) Pub. No.: US 2008/0249217 A1
(43) Pub. Date: Oct. 9, 2008

(54) Inkjet ink compositions comprising multiple modified pigments

(76) Inventors: Sze-Ming Lee, Westford, MA (US); Brian J. Creran, Brighton, MA (US)

Correspondence Address: LAW DEPARTMENT;CABOT CORPORATION, 157 CONCORD ROAD, BILLERICA, MA, 01821, US

(21) Appl. No.: 12/072,331

(22) Filed: Feb. 26, 2008

Related U.S. Application Data
(60) Provisional application No. 60/903,635, filed on Feb. 27, 2007.

(51) Int. Cl. C08L 33/12; C08L 33/08; C08K 5/095

(52) U.S. Cl. 524/284; 524/1; 524/287; 524/556; 524/560; 524/549

(57) ABSTRACT

The present invention relates to dispersions and inkjet ink compositions comprising a liquid vehicle and at least two modified pigments. The first modified pigment comprises a first pigment having attached at least one non-polymeric group, and the second modified pigment comprises a second pigment having attached at least one polymeric group.

### CROSS-REFERENCE TO RELATED APPLICATIONS

This patent application claims the benefit of U.S. Provisional Patent Application No. 60/903,635, filed Feb. 27, 2007.

### BACKGROUND OF THE INVENTION

1. Field of the Invention

The present invention relates to dispersions and inkjet ink compositions comprising at least two modified pigments.

2. Description of the Related Art

The surface of pigments contains a variety of different functional groups, and the types of groups present depend on the specific class of pigment. Several methods have been developed for grafting materials and, in particular, polymers to the surface of these pigments. For example, it has been shown that polymers can be attached to carbon blacks containing surface groups such as phenols and carboxyl groups. However, methods that rely on the inherent functionality of a pigment's surface cannot be applied generally because not all pigments have the same specific functional groups.

Methods for the preparation of modified pigment products have also been developed which can provide a pigment with a variety of different attached functional groups. For example, U.S. Pat. No. 5,851,280 discloses methods for the attachment of organic groups onto pigments including, for example, attachment via a diazonium reaction wherein the organic group is part of the diazonium salt.

Other methods to prepare modified pigments, including those having attached polymeric groups, have also been described. For example, PCT Publication No. WO 01/51566 discloses methods of making a modified pigment by reacting a first chemical group and a second chemical group to form a pigment having attached a third chemical group. Ink compositions, including inkjet inks, containing these pigments are also described. In addition, U.S. Pat. Nos. 5,672,198, 5,922,118, 6,042,643, and 6,641,656 disclose modified pigments having various attached groups, including phosphonic acid groups. Also, U.S. Pat. Nos. 6,328,894, 6,398,858, 6,436,178, 6,494,943, and 6,506,245 disclose modified pigments having various attached groups, including aryl polycarboxylic acid groups, including 1,2,3-benzene tricarboxylic acid groups. Compositions comprising these modified pigments, including inkjet ink compositions, are also shown. Also, polymer coated carbon products and methods for their preparation are described in U.S. Pat. No. 6,458,458.

While these methods provide modified pigments having attached groups, there remains a need for colorants having improved performance properties in compositions such as inkjet inks, thereby providing advantageous alternatives to previous modified pigments.

### SUMMARY OF THE INVENTION

The present invention relates to a dispersion comprising a liquid vehicle and at least two modified pigments. The first modified pigment comprises a first pigment having attached at least one non-polymeric group, and the second modified pigment comprises a second pigment having attached at least one polymeric group. In one embodiment, the amount of the first modified pigment is greater than 50% of the total amount of both modified pigments. In a second embodiment, both the non-polymeric group and the polymeric group comprise a carboxylic acid or salt thereof. The dispersion can be used as an inkjet ink composition.

It is to be understood that both the foregoing general description and the following detailed description are exemplary and explanatory only and are intended to provide further explanation of the present invention, as claimed.

### DETAILED DESCRIPTION OF THE INVENTION

The present invention relates to dispersions and inkjet ink compositions comprising a vehicle and at least two modified pigments.

The vehicle of the dispersion of the present invention can be either an aqueous or non-aqueous liquid vehicle, but is preferably a vehicle that contains water. Thus, the vehicle is preferably an aqueous vehicle, which is a vehicle that contains greater than 50% water and can be, for example, water or mixtures of water with water miscible solvents such as alcohols. Preferably the aqueous vehicle is water, and the dispersion is an aqueous dispersion.

The dispersion of the present invention further comprises at least two modified pigments, which are not the same. The first modified pigment comprises a first pigment having attached at least one first organic group and the second modified pigment comprises a second pigment having attached at least one second organic group. Each of the organic groups will be described in more detail below.

The first pigment and the second pigment can be the same or different, but are preferably at least the same color and, more preferably, the are same pigment. The first pigment and the second pigment can be any type of pigment conventionally used by those skilled in the art, such as carbonaceous black pigments and organic colored pigments including pigments comprising a blue, black, brown, cyan, green, white, violet, magenta, red, orange, or yellow pigment. Representative examples of black pigments include various carbon blacks (Pigment Black 7) such as channel blacks, furnace blacks, gas blacks, and lamp blacks, and include, for example, carbon blacks sold under the Regal®, Black Pearls®, Elftex®, Monarch®, Mogul®, and Vulcan® trademarks available from Cabot Corporation (such as Black Pearls® 2000, Black Pearls® 1400, Black Pearls® 1300, Black Pearls® 1100, Black Pearls® 1000, Black Pearls® 900, Black Pearls® 880, Black Pearls® 800, Black Pearls® 700, Black Pearls® L, Elftex® 8, Monarch® 1400, Monarch® 1300, Monarch® 1100, Monarch® 1000, Monarch® 900, Monarch® 880, Monarch® 800, Monarch® 700, Mogul® L, Regal® 330, Regal® 400, Vulcan® P). Suitable classes of colored pigments include, for example, anthraquinones, phthalocyanine blues, phthalocyanine greens, diazos, monoazos, pyranthrones, perylenes, heterocyclic yellows, quinacridones, quinolonoquinolones, and (thio)indigoids. Such pigments are commercially available in either powder or press cake form from a number of sources including, BASF Corporation, Engelhard Corporation and Sun Chemical Corporation. Examples of other suitable colored pigments are described in the Colour Index, 3rd edition (The Society of Dyers and Colourists, 1982). Preferably the pigment is a cyan, magenta, or yellow organic pigment or a carbonaceous black pigment, such as carbon black.

The first and second pigment can have a wide range of dibutylphthalate absorption (DBP) values, which is a measure of the structure or branching of the pigment. For example, the first pigment, the second pigment, or both may be a carbon black having a DBP value of from about 25 to 400 mL/100 g, including from about 30 to 200 mL/100 g and from about 50 to 150 mL/100 g. Preferably, the first pigment, the second pigment, or both are carbon blacks having a DBP value of less than or equal to about 100 mL/100 g, more preferably less than or equal to about 80 mL/100 g, and most preferably less than or equal to about 70 mL/100 g.

The first and second pigment can also have a wide range of BET surface areas, as measured by nitrogen adsorption, depending on the desired properties of the pigment. For example, the first pigment, the second pigment, or both may be a carbon black having a BET surface area of between about 10 m²/g and about 1500 m²/g, including between about 20 m²/g and about 600 m²/g and between about 50 m²/g and about 300 m²/g·surface area. Preferably, the first pigment, the second pigment, or both are carbon blacks having a BET surface area of greater than or equal to about 200 m²/g and more preferably greater than or equal to about 230 m²/g. Specific preferred examples include Black Pearls® 1100 and Monarch® 1100, commercially available from Cabot Corporation. Also, as is known to those skilled in the art, a higher surface area will correspond to smaller primary particle size. The pigment can also have a wide variety of primary particle sizes known in the art. For example, the pigment may have a primary particle size of between about 5 nm to about 100 nm, including about 10 nm to about 80 nm and 15 nm to about 50 nm. If, for example, a higher surface area for a colored pigment is not readily available for the desired application, it is also well recognized by those skilled in the art that the pigment may be subjected to conventional size reduction or commination techniques, such as ball or jet milling, to reduce the pigment to a smaller particle size, if desired.

As described above, the first modified pigment comprises a first pigment having attached at least one first organic group and the second modified pigment comprises a second pigment having attached at least one second organic group. Preferably both organic groups are directly attached. Each of these modified pigments may be prepared using any method known to those skilled in the art such that organic chemical groups are attached to the pigment. For example, the modified pigments can be prepared using the methods described in U.S. Pat. Nos. 5,554,739, 5,707,432, 5,837,045, 5,851,280, 5,885,335, 5,895,522, 5,900,029, 5,922,118, and 6,042,643, and PCT Publication WO 99/23174, the descriptions of which are fully incorporated herein by reference. Such methods provide for a more stable attachment of the groups onto the pigment compared to dispersant type methods, which use, for example, separate polymers and/or surfactants. Other methods for preparing the modified pigments include reacting a pigment having available functional groups with a reagent comprising the organic group, such as is described in, for example, U.S. Pat. No. 6,723,783, which is incorporated in its entirety by reference herein. Such functional pigments may be prepared using the methods described in the references incorporated above. In addition modified carbon blacks containing attached functional groups may also be prepared by the methods described in U.S. Pat. Nos. 6,831,194 and 6,660,075, U.S. Patent Publication Nos. 2003-0101901 and 2001-0036994, Canadian Patent No. 2,351,162, European Patent No. 1 394 221, and PCT Publication No. WO 04/63289, as well as in N. Tsubokawa, Polym. Sci., 17, 417, 1992, each of which is also incorporated in their entirety by reference herein.

The first modified pigment comprises a first pigment having attached at least one non-polymeric group. By “non-polymeric” is meant that the attached group cannot be prepared by a polymerization reaction, including, for example, free radical polymerization or condensation polymerization. Thus, the non-polymeric group has a defined molecular weight, whereas a polymeric group would be generally characterized by an average molecular weight, such as a number average or weight average molecular weight. Preferably, the non-polymeric group has a low molecular weight, preferably less than or equal to about 500, more preferably less than or equal to about 400, most preferably less than or equal to about 300, including less than or equal to about 250.

The non-polymeric group may further comprise at least one functional group. Preferably, the non-polymeric group comprises at least one ionic group, at least one ionizable group, or a mixture of an ionic group and an ionizable group. An ionic group is either anionic or cationic and is associated with a counterion of the opposite charge including inorganic or organic counterions such as Na⁺, K⁺, Li⁺, NH′₄⁺, NR′₁₄⁺, acetate, NO₃⁻, SO₄⁻², R′SO₃⁻, R′OSO₃⁻, OH⁻, and Cl⁻, where R′, which can be the same or different, represents hydrogen or an organic group such as a substituted or unsubstituted aryl and/or alkyl group. An ionizable group is one that is capable of forming an ionic group in the medium of use. Anionizable groups form anions and cationizable groups form cations. Preferably, the attached group is an organic group. Organic ionic groups include those described in U.S. Pat. No. 5,698,016, the description of which is fully incorporated herein by reference.

Anionic groups are negatively charged ionic groups that may be generated from groups having ionizable substituents that can form anions (anionizable groups), such as acidic substituents. They may also be the anion in the salts of ionizable substituents. Representative examples of anionic groups include —COO⁻, —SO₃⁻, —OSO₃⁻, —HPO₃⁻, OPO₃⁻², and —PO₃⁻². Representative examples of anionizable groups include —COOH, —SO₃H, —PO₃H₂, —R′SH, —R′OH, and —SO₂NHCOR′, where R′, which can be the same or different, represents hydrogen or an organic group such as a substituted or unsubstituted aryl and/or alkyl group.

Cationic groups are positively charged organic ionic groups that may be generated from ionizable substituents that can form cations (cationizable groups), such as protonated amines. For example, alkyl or aryl amines may be protonated to form ammonium groups —NR′₂H⁺, where R′ represent an organic group such as a substituted or unsubstituted aryl and/or alkyl group. Cationic groups may also be positively charged organic ionic groups. Examples include quaternary ammonium groups (—NR′₃⁺) and quaternary phosphonium groups (—PR′₃⁺). Here, R′ represents hydrogen or an organic group such as a substituted or unsubstituted aryl and/or alkyl group.

Preferably, the non-polymeric group comprises an anionic or anionizable group, and, more preferably, comprises an acid group or a salt thereof, such as a carboxylic acid group, a sulfonic acid group, a phosphonic acid group, or salts thereof. Specific examples of preferred non-polymeric groups include groups having the formula —X—(CO₂)ₙ⁻M⁺, wherein X, which is attached to the pigment, is an arylene, heteroarylene, alkylene, alkarylene, or aralkylene group. M⁺ is H⁺, Na⁺, K⁺, Li⁺, or NR₄⁺, wherein R, which can be the same or different, represents hydrogen or an organic group such as a substituted or unsubstituted aryl and/or alkyl group, and n is 1 to 4, especially 1 or 2. More preferably, X is an arylene group, and the non-polymeric group comprises an arylene acid group or a salt thereof, such as an arylene carboxylic acid group, an arylene sulfonic acid group, an arylene phosphonic acid group, or salts thereof, including, for example, groups having the formula —C₆H₄COOH or —C₆H₄—CO₂⁻M⁺.

The amount of attached non-polymeric group can be varied, depending on the desired properties of the pigment and the type of attached group. For example, the total amount of non-polymeric group may be from about 0.01 to about 10.0 micromoles of groups/m² surface area of the first pigment, as measured by nitrogen adsorption (BET method), including from about 0.5 to about 5.0 micromoles/m², from about 1 to about 3 micromoles/m², or from about 2 to about 2.5 micromoles/m². Additional attached non-polymeric groups, which differ from each other, may also be present.

The second modified pigment comprises a second pigment having attached at least one polymeric group. As discussed above, a “polymeric” group is one that can be prepared by a polymerization reaction. Thus, the polymeric group attached to the second pigment comprises a polymer, and this can be prepared using any method known in the art. For example, the polymer of the polymeric group can be prepared by the polymerization of one or more radically polymerizable monomers. Such monomers may provide the polymer with additional desirable properties, particularly useful in an inkjet ink composition. Examples include, but are not limited to, acrylic and methacrylic acid, acrylate esters, methacrylate esters, acrylamides and methacrylamides, acrylonitriles, cyanoacrylate esters, maleate and fumarate diesters, vinyl pyridines, vinyl N-alkylpyrroles, vinyl acetate, vinyl oxazoles, vinyl thiazoles, vinyl pyrimidines, vinyl imidazoles, vinyl ketones, vinyl ethers, and styrenes. Vinyl ketones include those in which the β-carbon atom of the alkyl group does not bear a hydrogen atom, such as vinyl ketones in which both β-carbons bear a C1-C4 alkyl group, halogen, etc. or a vinyl phenyl ketone in which the phenyl group may be substituted with from 1 to 5 C1-C6 alkyl groups and/or halogen atoms. Styrenes include those in which the vinyl group is substituted with a C1-C6 alkyl group, such as at the α-carbon atom, and/or those in which the phenyl group is substituted with from 1 to 5 substituents including a C1-C6 alkyl, alkenyl (including vinyl), or alkynyl (including acetylenyl) group, a phenyl group, a haloalkyl group, and functional groups such as C1-C6 alkoxy, halogen, nitro, carboxy, sulfonate, C1-C6 alkoxycarbonyl, hydroxy (including those protected with a C1-C6 acyl group), and cyano groups. Specific examples include methyl acrylate (MA), methyl methacrylate (MMA), ethyl acrylate (EA), ethyl methacrylate (EMA), butyl acrylate (BA), 2-ethylhexyl acrylate (EHA), acrylonitrile (AN), methacrylonitrile, styrene, and derivatives thereof.

The polymer of the polymeric group can also be prepared by the cationic or anionic polymerization of one or more polymerizable monomers. For example, polyvinyl ethers can be prepared by cationic polymerization of monomers, such as those having the general structure CH₂═CH(OR), wherein R is an alkyl, aralkyl, alkaryl, or aryl group or is a group comprising one or more alkylene oxide groups. Other cationically or anionically polymerizable monomers can also be included. In addition, the polymer of the polymeric group can also be prepared by polycondensation techniques. For example, the polymer may be a polyester or a polyurethane.

The polymer of the polymeric group can be a homopolymer, copolymer, terpolymer, and/or a polymer containing any number of different repeating units. Further, the polymer can be a random polymer, branched polymer, alternating polymer, graft polymer, block polymer, star-like polymer, and/or comb-like polymer. The type of attached polymer can be varied depending on the intended application. For example, the polymeric group may comprise a polymer comprising acid groups and having an acid number of less than 200, such as less than 150, or less than 100, or less than 50. Acid numbers can be determined using any method known in the art, including titration with a strong base such as KOH. Specific examples include acid numbers between 100 and 200, between 50 and 100, and between 0 and 50. Also, the polymeric group may comprise a polymer having a Tg less than 100, such as between 50 and 100, and preferably less than 50. Furthermore, the polymeric group may comprise a polymer having a molecular weight (Mw) of between about 500-100,000, such as between about 1000 and 50,000, between about 2,000 and 25,000, and between about 5,000 and 20,000. The polydispersity of the polymer of the polymeric group is generally less than 3, such as less than 2.5, and less than 2. Alternatively, the molecular weight distribution may be polymodal, such as bimodal.

Specific examples of polymeric groups include polyvinyl alcohol groups, polyvinylpyrrolidone groups, polyurethane groups, acrylate or methacrylate polymeric groups (such as homopolymeric or copolymeric groups prepared from methacrylic acid, acrylic acid, or esters thereof), poly(styrene-acrylate) or poly(styrene-methacrylate) groups (such as copolymeric groups prepared from styrene and methacrylic acid, acrylic acid, or esters thereof), polymeric groups prepared from styrene and maleic acid or maleic anhydride, polymer groups prepared from vinyl acetate (such as vinyl acetate-ethylene copolymeric groups, vinyl acetate-fatty acid vinyl ethylene copolymer groups, vinyl acetate-maleate ester copolymer groups, vinyl acetate-crotonic acid copolymer groups, and vinyl acetate-acrylic acid copolymer groups), and salts thereof. Preferably the polymeric group comprises at least one anionic group, at least one anionizable group, or a mixture thereof. More preferably, the polymeric group comprises at least one acid group or salt thereof, such as at least one carboxylic acid group or salt thereof. For example, preferred polymeric groups include methacrylate or acrylate polymeric groups, such as styrene-acrylic acid polymeric groups and styrene-methacrylic acid polymeric groups, or maleic acid or maleic anhydride polymeric groups, or salts thereof. Suitable salts include inorganic or organic counterions such as Na⁺, K⁺, Li⁺, NH₄⁺, NR′₄⁺, where R′, which can be the same or different, represents hydrogen or an organic group such as a substituted or unsubstituted aryl and/or alkyl group.

The second modified pigment comprising a second pigment having attached at least one polymeric group may be prepared using a variety of different techniques. For example, the second modified pigment may be prepared by the reaction of a functional group of a polymer with a functional group of the second pigment (as shown in, for example, U.S. Pat. No. 6,723,783, U.S. Patent Publication No. 2004/0229975, or European Patent No. 0 272 127), including the reaction of an end or terminal functional polymer and a pigment, or the reaction of an amine-containing functional group of a polymer, including end or terminal functional polymers, with a diazotizing agent which is then further reacted with a pigment (as shown in, for example, U.S. Pat. No. 6,478,863). The second modified pigment may also be prepared by polymerization of monomers from the second pigment. For example, the second modified pigment may be prepared by radical polymerization, controlled polymerization methods, such as atom transfer radical polymerization (ATRP), stable free radical (SFR) polymerization, and reversible addition-fragmentation chain transfer polymerization (RAFT), ionic polymerizations (anionic or cationic) such as group transfer polymerization (GTP), and condensation polymerization. Also, the second modified pigment may be prepared using the methods described in, for example, U.S. Pat. Nos. 6,372,820; 6,350,519; 6,551,393; or 6,368,239 or in International Patent Publication Nos. 2006/086599 and 2006/086660. Each of these references are incorporated in their entirety by reference herein.

The amount of attached polymeric group can be varied, depending on the desired properties of the pigment and the type of attached group. For example, the total amount of polymeric group may be from 0.1 to 50% by weight of the second pigment, preferably 1% to 45%, and more preferably 10% to 40% by weight of the second pigment.

In a preferred embodiment of the present invention, the first modified pigment comprises a first pigment having attached at least one non-polymeric group which comprises a carboxylic acid group or salt thereof and the second modified pigment comprises a second pigment having attached at least one polymeric group which also comprises a carboxylic acid group. It has surprisingly been found that a dispersion comprising this combination of modified pigments has performance properties which are unexpected based on the performance properties of dispersions comprising either of these modified pigments alone and also based on the performance properties of dispersions comprising combinations of modified pigments not having carboxylic acid groups. In particular, when these dispersions are used in an inkjet ink application, unexpected improvements in print performance, particularly gloss, distinctness of image, and durability, have been found.

Both the first modified pigment and the second modified pigment can be present in the dispersion of the present invention in a total amount effective to provide desired overall performance properties, such as, for example, image quality, when used in an inkjet ink composition, without detrimentally affecting the properties of the dispersion itself, such as dispersion stability. Typically, the total amount of modified pigment is from about 0.1% to about 30% based on the weight of the dispersion.

The relative amounts of the first modified pigment to the second modified pigment can also be varied. However, preferably the dispersion of the present invention comprises a relatively greater amount of the first modified pigment compared to the amount of the second modified pigment. For example, in another preferred embodiment of the dispersion of the present invention, if the first modified pigment is present in an amount X, and the second modified pigment is present in an amount Y, then, for the dispersion of the present invention, X/(X+Y), which is the fraction of first modified pigment compared to the total amount of pigment, is greater than 0.5. Thus, the first modified pigment is greater than 50% of the total modified pigment. Preferably, X/(X+Y) is from 0.55 to 0.9, more preferably 0.6 to 0.8. If more than one first modified pigment is present, then X refers to the total amount of first modified pigment, and, if more than one second modified pigment is present, then Y refers to the total amount of second modified pigment. It has surprisingly been found that dispersions comprising more of a first modified pigment, described above, relative to the amount of the second modified pigment, described above, have improved performance properties compared to dispersions comprising more of the second modified pigment than the first modified pigment, or equal amounts of each. In particular, when used in an inkjet ink application, unexpected improvements in print performance have been found.

The dispersions of the present invention may be purified or classified to remove impurities and other undesirable free species that can co-exist in the dispersion as a result of the manufacturing process. For example, the dispersion can be purified to remove any undesired free species, such as unreacted treating agent using known techniques such as ultrafiltration/diafiltration, reverse osmosis, or ion exchange. Preferably, the large particle concentration of the dispersion is also reduced in order to improve the overall dispersion stability. Thus, for example, particles having a size greater than 500 nm can be removed using techniques such as centrifugation.

The dispersions of the present invention, comprising at least two different modified pigments as described above, can be used in a variety of different applications, including, for example, the preparation of plastic compositions, aqueous or non-aqueous inks, aqueous or non-aqueous coatings, rubber compositions, paper compositions and textile compositions. In particular, these dispersions may used in aqueous compositions, including, for example, automotive and industrial coatings, paints, toners, adhesives, latexes, and inks. The dispersions have been found to be most useful in ink compositions, especially inkjet ink compositions.

Thus, the present invention further relates to an inkjet ink composition comprising a vehicle and at least two modified pigments—a first modified pigment comprising a first pigment having attached at least one non-polymeric group and a second modified pigment comprising a second pigment having attached at least one polymeric group. The vehicle and modified pigments can be any of those described above. Inkjet ink compositions comprising these two modified pigments have been found to have surprising print performance properties compared to inkjet ink compositions comprising either modified pigment individually, particularly when the amount of the first modified pigment is greater than the amount of the second modified pigment. For example, if an inkjet ink composition comprising the first modified pigment produces printed images having higher gloss and distinctness of image (DOI) than images produced from an inkjet ink composition comprising the second modified pigment, each at the same pigment loading level, it has surprisingly been found that an inkjet ink composition comprising a combination of these modified pigments can also have a similarly high gloss and DOI. As another example, if the inkjet ink composition comprising the second modified pigment has one desired property, such as high resistance to smear or waterfastness, compared to an inkjet ink composition comprising the first modified pigment, having, for example, a high gloss, it has surprisingly been found that the inkjet ink composition of the present invention, comprising both modified pigments, can have both high gloss and improved resistance to smear and waterfastness.

The inkjet ink composition of the present invention can be formed with a minimum of additional components (additives and/or cosolvents) and processing steps. However, suitable additives may be incorporated in order to impart a number of desired properties while maintaining the stability of the compositions. For example, surfactants and/or dispersants, humectants, drying accelerators, penetrants, biocides, binders, and pH control agents, as well as other additives known in the art, may be added. The amount of a particular additive will vary depending on a variety of factors but generally ranges between 0% and 40%. It is also within the bounds of the present invention to use a additional colorants, including, for example, other modified pigments, unmodified pigments, or oxidized pigments including self-dispersible oxidized pigments prepared using peroxide, ozone, persulfate, and hypohalites (some of which are commercially available from Rohm and Haas or Orient), other modified pigments, or both. Furthermore, it is also within the bounds of the present invention to use polymer modified pigments comprising a pigment that has been encapsulated by a polymer, including any of the polymers described above relating to the attached polymeric group. Also, mixtures of modified colorants wherein one colorant comprises a dye and one colorant comprises a pigment may also be used.

Dispersing agents (surfactants and/or dispersants) may be added to further enhance the colloidal stability of the composition or to change the interaction of the ink with either the printing substrate, such as printing paper, or with the ink printhead. Various anionic, cationic and nonionic dispersing agents can be used in conjunction with the ink composition of the present invention, and these may be in solid form or as a water solution.

Representative examples of anionic dispersants or surfactants include, but are not limited to, higher fatty acid salts, higher alkyldicarboxylates, sulfuric acid ester salts of higher alcohols, higher alkyl-sulfonates, alkylbenzenesulfonates, alkylnaphthalene sulfonates, naphthalene sulfonates (Na, K, Li, Ca, etc.), formalin polycondensates, condensates between higher fatty acids and amino acids, dialkylsulfosuccinic acid ester salts, alkylsulfosuccinates, naphthenates, alkylether carboxylates, acylated peptides, α-olefin sulfonates, N-acrylmethyl taurine, alkylether sulfonates, secondary higher alcohol ethoxysulfates, polyoxyethylene alkylphenylether sulfates, monoglycylsulfates, alkylether phosphates and alkyl phosphates, alkyl phosphonates and bisphosphonates, included hydroxylated or aminated derivatives. For example, polymers and copolymers of styrene sulfonate salts, unsubstituted and substituted naphthalene sulfonate salts (e.g. alkyl or alkoxy substituted naphthalene derivatives), aldehyde derivatives (such as unsubstituted alkyl aldehyde derivatives including formaldehyde, acetaldehyde, propylaldehyde, and the like), maleic acid salts, and mixtures thereof may be used as the anionic dispersing aids. Salts include, for example, Na⁺, Li⁺, K⁺, Cs⁺, Rb⁺, and substituted and unsubstituted ammonium cations. Specific examples include, but are not limited to, commercial products such as Versa® 4, Versa® 7, and Versa® 77 (National Starch and Chemical Co.); Lomar® D (Diamond Shamrock Chemicals Co.); Daxad®19 and Daxad® K (W. R. Grace Co.); and Tamol® SN (Rohm & Haas). Representative examples of cationic surfactants include aliphatic amines, quaternary ammonium salts, sulfonium salts, phosphonium salts and the like.

Representative examples of nonionic dispersants or surfactants that can be used in ink jet inks of the present invention include fluorine derivatives, silicone derivatives, acrylic acid copolymers, polyoxyethylene alkyl ether, polyoxyethylene alkylphenyl ether, polyoxyethylene secondary alcohol ether, polyoxyethylene styrol ether, ethoxylated acetylenic diols (such as Surfynol® 420, Surfynol® 440, and Surfynol® 465, available from Air Products), polyoxyethylene lanolin derivatives, ethylene oxide derivatives of alkylphenol formalin condensates, polyoxyethylene polyoxypropylene block polymers, fatty acid esters of polyoxyethylene polyoxypropylene alkylether polyoxyethylene compounds, ethylene glycol fatty acid esters of polyethylene oxide condensation type, fatty acid monoglycerides, fatty acid esters of polyglycerol, fatty acid esters of propylene glycol, cane sugar fatty acid esters, fatty acid alkanol amides, polyoxyethylene fatty acid amides and polyoxyethylene alkylamine oxides. For example, ethoxylated monoalkyl or dialkyl phenols may be used, such as Igepal® CA and CO series materials (Rhone-Poulenc Co.), Brij® Series materials (ICI Americas, Inc.), and Triton® series materials (Dow Company). These nonionic surfactants or dispersants can be used alone or in combination with the aforementioned anionic and cationic dispersants.

The dispersing agents may also be a natural polymer or a synthetic polymer dispersant. Specific examples of natural polymer dispersants include proteins such as glue, gelatin, casein and albumin; natural rubbers such as gum arabic and tragacanth gum; glucosides such as saponin; alginic acid, and alginic acid derivatives such as propyleneglycol alginate, triethanolamine alginate, and ammonium alginate; and cellulose derivatives such as methyl cellulose, carboxymethyl cellulose, hydroxyethyl cellulose and ethylhydroxy cellulose. Specific examples of polymeric dispersants, including synthetic polymeric dispersants, include polyvinyl alcohols, such as Elvanols from DuPont, Celvoline from Celanese, polyvinylpyrrolidones such as Luvatec from BASF, Kollidon and Plasdone from ISP, and PVP-K, Glide, acrylic or methacrylic resins (often written as “(meth)acrylic”) such as poly(meth)acrylic acid, Ethacryl line from Lyondell, Alcosperse from Alco, acrylic acid-(meth)acrylonitrile copolymers, potassium (meth)acrylate-(meth)acrylonitrile copolymers, vinyl acetate-(meth)acrylate ester copolymers and (meth)acrylic acid-(meth)acrylate ester copolymers; styrene-acrylic or methacrylic resins such as styrene-(meth)acrylic acid copolymers, such as the Joncryl line from BASF, Carbomers from Noveon, styrene-(meth)acrylic acid-(meth)acrylate ester copolymers, such as the Joncryl polymers from BASF, styrene-α-methylstyrene-(meth)acrylic acid copolymers, styrene-α-methylstyrene-(meth)acrylic acid-(meth)acrylate ester copolymers; styrene-maleic acid copolymers; styrene-maleic anhydride copolymers, such as the SMA polymers from Sartomer, vinyl naphthalene-acrylic or methacrylic acid copolymers; vinyl naphthalene-maleic acid copolymers; and vinyl acetate copolymers such as vinyl acetate-ethylene copolymer, vinyl acetate-fatty acid vinyl ethylene copolymers, vinyl acetate-maleate ester copolymers, vinyl acetate-crotonic acid copolymer and vinyl acetate-acrylic acid copolymer; and salts thereof. Polymers, such as those listed above, variations and related materials, that can be used for dispersants and additives in inkjet inks are included in the Tego products from Degussa, the Ethacryl products from Lyondell, the Joncryl polymers from BASF, the EFKA dispersants from Ciba, and the Disperbyk and Byk dispersants from BYK Chemie.

Humectants and water soluble organic compounds may also be added to the inkjet ink composition of the present invention, particularly for the purpose of preventing clogging of the nozzle as well as for providing paper penetration (penetrants), improved drying (drying accelerators), and anti-cockling properties. Specific examples of humectants and other water soluble compounds that may be used include low molecular-weight glycols such as ethylene glycol, diethylene glycol, triethylene glycol, tetraethylene glycol and dipropylene glycol; diols containing from about 2 to about 40 carbon atoms, such as 1,3-pentanediol, 1,4-butanediol, 1,5-pentanediol, 1,4-pentanediol, 1,6-hexanediol, 1,5-hexanediol, 2,6-hexanediol, neopentylglycol (2,2-dimethyl-1,3-propanediol), 1,3-propanediol, 1,4-butanediol, 1,5-pentanediol, 1,6-hexanediol, 1,2,6-hexanetriol, poly(ethylene-co-propylene) glycol, and the like, as well as their reaction products with alkylene oxides, including ethylene oxides, including ethylene oxide and propylene oxide; triol derivatives containing from about 3 to about 40 carbon atoms, including glycerine, trimethylolpropane, 1,3,5-pentanetriol, 1,2,6-hexanetriol, and the like as well as their reaction products with alkylene oxides, including ethylene oxide, propylene oxide, and mixtures thereof; neopentylglycol, (2,2-dimethyl-1,3-propanediol), and the like, as well as their reaction products with alkylene oxides, including ethylene oxide and propylene oxide in any desirable molar ratio to form materials with a wide range of molecular weights; thiodiglycol; pentaerythritol and lower alcohols such as ethanol, propanol, iso-propyl alcohol, n-butyl alcohol, sec-butyl alcohol, and tert-butyl alcohol, 2-propyn-1-ol (propargyl alcohol), 2-buten-1-ol, 3-buten-2-ol, 3-butyn-2-ol, and cyclopropanol; amides such as dimethyl formaldehyde and dimethyl acetamide; ketones or ketoalcohols such as acetone and diacetone alcohol; ethers such as tetrahydrofuran and dioxane; cellosolves such as ethylene glycol monomethyl ether and ethylene glycol monoethyl ether, triethylene glycol monomethyl (or monoethyl)ether; carbitols such as diethylene glycol monomethyl ether, diethylene glycol monoethyl ether, and diethylene glycol monobutyl ether; lactams such as 2-pyrrolidone, N-methyl-2-pyrrolidone and ε-caprolactam; urea and urea derivatives; inner salts such as betaine, and the like; thio (sulfur) derivatives of the aforementioned materials including 1-butanethiol; t-butanethiol 1-methyl-1-propanethiol, 2-methyl-1-propanethiol; 2-methyl-2-propanethiol; thiocyclopropanol, thioethyleneglycol, thiodiethyleneglycol, trithio- or dithio-diethyleneglycol, and the like; hydroxyamide derivatives, including acetylethanolamine, acetylpropanolamine, propylcarboxyethanolamine, propylcarboxy propanolamine, and the like; reaction products of the aforementioned materials with alkylene oxides; and mixtures thereof. Additional examples include saccharides such as maltitol, sorbitol, gluconolactone and maltose; polyhydric alcohols such as trimethylol propane and trimethylol ethane; N-methyl-2-pyrrolidone; 1,3-dimethyl-2-imidazolidinone; sulfoxide derivatives containing from about 2 to about 40 carbon atoms, including dialkylsulfides (symmetric and asymmetric sulfoxides) such as dimethylsulfoxide, methylethylsulfoxide, alkylphenyl sulfoxides, and the like; and sulfone derivatives (symmetric and asymmetric sulfones) containing from about 2 to about 40 carbon atoms, such as dimethylsulfone, methylethylsulfone, sulfolane (tetramethylenesulfone, a cyclic sulfone), dialkyl sulfones, alkyl phenyl sulfones, dimethylsulfone, methylethylsulfone, diethylsulfone, ethylpropylsulfone, methylphenylsulfone, methylsulfolane, dimethylsulfolane, and the like. Such materials may be used alone or in combination.

Biocides and/or fungicides may also be added to the inkjet ink composition of the present invention. Biocides are important in preventing bacterial growth since bacteria are often larger than ink nozzles and can cause clogging as well as other printing problems. Examples of useful biocides include, but are not limited to, benzoate or sorbate salts, and isothiazolinones.

Various polymeric binders can also be used in conjunction with the inkjet ink composition of the present invention to adjust the viscosity of the composition as well as to provide other desirable properties. Suitable polymeric binders include, but are not limited to, water soluble polymers and copolymers such as gum arabic, polyacrylate salts, polymethacrylate salts, polyvinyl alcohols (Elvanols from DuPont, Celvoline from Celanese), hydroxypropylenecellulose, hydroxyethylcellulose, polyvinylpyrrolidinone (such as Luvatec from BASF, Kollidon and Plasdone from ISP, and PVP-K, Glide), polyvinylether, starch, polysaccharides, polyethyleneimines with or without being derivatized with ethylene oxide and propylene oxide including the Discole® series (DKS International); the Jeffamine® series (Huntsman); and the like. Additional examples of water-soluble polymer compounds include various dispersants or surfactants described above, including, for example, styrene-acrylic acid copolymers (such as the Joncryl line from BASF, Carbomers from Noveon), styrene-acrylic acid-alkyl acrylate terpolymers, styrene-methacrylic acid copolymers (such as the Joncryl line from BASF), styrene-maleic acid copolymers (such as the SMA polymers from Sartomer), styrene-maleic acid-alkyl acrylate terpolymers, styrene-methacrylic acid-alkyl acrylate terpolymers, styrene-maleic acid half ester copolymers, vinyl naphthalene-acrylic acid copolymers, alginic acid, polyacrylic acids or their salts and their derivatives. In addition, the binder may be added or present in dispersion or latex form. For example, the polymeric binder may be a latex of acrylate or methacrylate copolymers (such as NeoCryl materials from NSM Neoresins, the AC and AS polymers from Alberdingk-Boley) or may be a water dispersible polyurethane (such as ABU from Alberdingk-Boley) or polyester (such as AQ polymers from Eastman Chemical). Polymers, such as those listed above, variations and related materials, that can be used for binders in inkjet inks are included in the Ethacryl products from Lyondell, the Joncryl polymers from BASF, the NeoCryl materials from NSM Neoresins, and the AC and AS polymers Alberdingk-Boley.

Various additives for controlling or regulating the pH of the inkjet ink composition of the present invention may also be used. Examples of suitable pH regulators include various amines such as diethanolamine and triethanolamine as well as various hydroxide reagents. An hydroxide reagent is any reagent that comprises an OH⁻ ion, such as a salt having an hydroxide counterion. Examples include sodium hydroxide, potassium hydroxide, lithium hydroxide, ammonium hydroxide, and tetramethyl ammonium hydroxide. Other hydroxide salts, as well as mixtures of hydroxide reagents, can also be used. Furthermore, other alkaline reagents may also be used which generate OH⁻ ions in an aqueous medium. Examples include carbonates such as sodium carbonate, bicarbonates such as sodium bicarbonate, and alkoxides such as sodium methoxide and sodium ethoxide. Buffers may also be added.

Additionally, the inkjet ink composition of the present invention may further incorporate conventional dyes to modify color balance and adjust optical density. Such dyes include food dyes, FD&C dyes, acid dyes, direct dyes, reactive dyes, derivatives of phthalocyanine sulfonic acids, including copper phthalocyanine derivatives, sodium salts, ammonium salts, potassium salts, lithium salts, and the like.

The inkjet ink composition can be purified and/or classified using methods such as those described above for the modified pigments of the present invention. An optional counterion exchange step can also be used. Thus, unwanted impurities or undesirable large particles can be removed to produce an ink with good overall properties.

The present invention further relates to an inkjet ink set which comprises various inkjet ink compositions and includes the inkjet ink composition of the present invention. The inkjet ink compositions of this set may differ in any way known in the art. For example, the inkjet ink set may comprise inkjet ink compositions comprising different types and/or colors of colorants, including, for example, an inkjet ink composition comprising a cyan pigment, an inkjet ink composition comprising a magenta pigment, and/or an inkjet ink composition comprising a black pigment. Other types of inkjet ink compositions may also be used, including, for example, compositions comprising agents designed to fix the inkjet ink compositions onto the substrate. Other combinations will be known in the art.

The present invention will be further clarified by the following examples, which are intended to be only exemplary in nature.

### EXAMPLES

### Example 1

The following example describes the preparation and print performance properties of inkjet ink compositions of the present invention comprising a first modified pigment and a second modified pigment, wherein the first modified pigment comprises a pigment having attached at least one non-polymeric group comprising a carboxylic acid group or salt thereof and the second modified pigment comprises a pigment having attached at least one polymeric group comprising a carboxylic acid group or salt thereof.

For this example, an aqueous dispersion of a modified carbon black comprising a carbon black having attached benzoic acid groups or salts thereof (the first modified pigment) was prepared by reacting Black Pearls® 1100 carbon black (commercially available from Cabot Corporation having a BET nitrogen surface area of 240 m²/g and a DBP value of 50 cc/100 g) with p-aminobenzoic acid (1.5 mmoles per gram of carbon black) and sodium nitrite (equimolar to p-aminobenzoic acid). Also, a dispersion of a modified carbon black comprising a carbon black having attached a styrene-acrylic acid copolymer (the second modified pigment) was prepared by reacting Black Pearls® 1100 carbon black with aminobenzyl amine (1.0 mmole per gram of carbon black), methanesulfonic acid (2 moles per mole of aminobenzyl amine), and sodium nitrite (equimolar to aminobenzyl amine) to form a carbon black having attached amino groups which was then reacted with Joncryl® 690 (a styrene-acrylic acid copolymer available from BASF having an acid number of 240 and a weight average molecular weight of 16,000, 3/1 by weight polymer to pigment).

Inkjet ink compositions of the present invention were prepared by combining a base composition comprising the first modified pigment (Base 1-1) and a base composition comprising the second modified pigment (Base 2-1) in varying ratios. The two base compositions are shown in Table 1 below, and the amounts of each base composition used to prepare the inkjet ink compositions of the present invention are shown in Table 2 below.

TABLE 1

| | Base 1-1 | Base 2-1 |
|---|---|---|
| First modified pigment | 4% | — |
| Second modified pigment | — | 4% |
| trimethylolpropane | 7% | 7% |
| diethyleneglycol | 5% | 5% |
| Surfynol 465 | 1% | 1% |
| glycerin | 7% | 7% |
| Water | 76% | 76% |

TABLE 2

| | Amount | | Wt fraction | |
|---|---|---|---|---|
| | Base 1-1 | Base 2-1 | First pigment | Second pigment |
| Ex 1A | 84.2 | 30.2 | 0.736 | 0.264 |
| Ex 1B | 73.7 | 45.3 | 0.619 | 0.381 |
| Ex 1C | 63.2 | 60.4 | 0.511 | 0.489 |
| Ex 1D | 52.6 | 75.5 | 0.411 | 0.589 |

Total pigment loading in each inkjet ink composition was 4%. In Table 2, the weight fraction is shown, which is the ratio of the specified pigment to the total amount of pigment in the inkjet ink composition. Thus, if the amount of the first modified pigment is X and the amount of the second modified pigment is Y, the weight fraction of the first modified pigment is X/(X+Y).

The inkjet ink compositions of the present invention (Examples 1A, 1B, 1C, and 1D) as well as the base compositions from which they were prepared (Base 1-1 and 2-1) were printed using a Canon i550 printer onto Canon PP-101 and Canon PR-101 photoglossy paper with the following print settings: print quality—high, color adjustment—default, grayscale printing checked. Print performance properties were determined from the resulting printed images after allowing 15 minutes for drying. Gloss (20°) was measured with a Micro Tri Gloss meter, model 4430, and the distinctness of image (DOI) was measured with QEA DIAS. Wet smear resistance was determined by rubbing a moist kimwipe across the printed image 5 times and visually evaluated for evidence of smearing from the printed stripe onto the glossy paper (“pass” means no smear, “trace” means little smear, and “fail” means visible smear). Waterfastness (WF) was determined by dripping water across a printed image and visually evaluated using the same scale. Print performance results are shown in Table 3a (for images printed on Canon PP-101) and Table 3b (for images printed on Canon PR-101) below.

TABLE 3a

| | Wt fraction | | | | | |
|---|---|---|---|---|---|---|
| | | Second | | | | |
| | First pigment | pigment | Gloss | DOI | Wet Smear | WF |
| Base 1-1 | 1 | 0 | 152 | 3.7 | fail | fail |
| Ex 1A | 0.736 | 0.264 | 130 | 3.5 | pass | pass |
| Ex 1B | 0.619 | 0.381 | 130.9 | 3.24 | pass | pass |
| Ex 1C | 0.511 | 0.489 | 131 | 3.1 | pass | pass |
| Ex 1D | 0.411 | 0.589 | 117.5 | 2.8 | pass | pass |
| Base 2-1 | 0 | 1 | 59 | 1.7 | pass | pass |

TABLE 3b

| | Wt fraction | | | | | |
|---|---|---|---|---|---|---|
| | First | | | | Wet | |
| | pigment | Second pigment | Gloss | DOI | Smear | WF |
| Base 1-1 | 1 | 0 | 120 | 2.8 | fail | trace |
| Ex 1A | 0.736 | 0.264 | 112 | 2.6 | fail | trace |
| Ex 1B | 0.619 | 0.381 | 103.5 | 2.5 | fail | trace |
| Ex 1C | 0.511 | 0.489 | 102 | 2.45 | pass | trace |
| Ex 1D | 0.411 | 0.589 | 100.5 | 2.55 | pass | pass |
| Base 2-1 | 0 | 1 | 52 | 1.4 | pass | pass |

As the data shows, the inkjet ink compositions of the present invention have performance properties that would not have been expected based on the performance of the base compositions from which they were prepared. For example, the 200 gloss value for Base 1-1 is 152 on PP-101 while that of Base 2-1 is 59. The inkjet ink compositions of Examples 1A, 1B, 1C, and 1D have gloss values greater than what would be expected based on the weighted average of these values. In addition, while the gloss value for Base 2-1 is 59, it has surprisingly been found that inkjet ink compositions comprising 4% pigment in which as high as 58.9% is this lower gloss pigment (Example 1D) can still have very high gloss. The same is true for DOI. Thus, it has been found that a higher gloss, higher DOI pigment (from Base 1-1) can be combined with a lower gloss, lower DOI pigment (from Base 2-1), producing an inkjet ink composition having high overall gloss and DOI. Furthermore, each of Example 1A-1D have improved or similar wet smear and waterfastness properties compared to Base 1-1, even though as high as 73.6% of the total pigment is from Base 1-1.

Therefore, the inkjet ink compositions of the present invention, comprising two different modified pigments, have surprisingly been found to have a balance of good print performance properties, and this combination of properties would not be expected based on the performance of base compositions comprising either modified pigment individually, based on the weighted average. Particularly improved properties have been found when the amount of the first modified pigment (from Base 1-1) is greater than 50% of the total amount of pigment.

### Example 2

The following example describes the preparation and print performance properties of inkjet ink compositions of the present invention comprising a first modified pigment and a second modified pigment, wherein the first modified pigment comprises a pigment having attached at least one non-polymeric group comprising a carboxylic acid group or salt thereof and the second modified pigment comprises a pigment having attached at least one polymeric group comprising a carboxylic acid group or salt thereof.

For this example, an aqueous dispersion of a modified carbon black comprising a carbon black having attached benzoic acid groups or salts thereof (the first modified pigment) was prepared by reacting Black Pearls® 700 carbon black (commercially available from Cabot Corporation having a BET nitrogen surface area of 200 m²/g and a DBP value of 117 cc/100 g) with p-aminobenzoic acid (0.8 mmoles per gram of carbon black) and sodium nitrite (equimolar to p-aminobenzoic acid). Also, a dispersion of a modified carbon black comprising a carbon black having attached a styrene-acrylic acid copolymer (the second modified pigment) was prepared by reacting Black Pearls® 700 carbon black with 4-aminophenyl-2-sulfatoethylsulfone (APSES, 0.5 mmoles per gram of carbon black) and sodium nitrite (equimolar to APSES) to form a carbon black having attached sulfoethylsulfonate groups which was then reacted with pentaethylenehexamine (PEHA, 1.4 mmoles per gram of carbon black) followed by Joncryl™ 683 (a styrene-acrylic acid copolymer available from BASF having an acid number of 160 and a weight average molecular weight of 8,000, 1/1 by weight polymer to pigment).

Inkjet ink compositions of the present invention were prepared by combining a base composition comprising the dispersion of the first modified pigment (Base 1-2) and a base composition comprising the dispersion of the second modified pigment (Base 2-2) in varying ratios. The two base compositions are shown in Table 4 below, and the amounts of each base composition used to prepare the inkjet ink compositions of the present invention are shown in Table 5 below.

TABLE 4

| | Base 1-2 | Base 2-2 |
|---|---|---|
| First modified pigment | 4% | — |
| Second modified pigment | — | 4% |
| trimethylolpropane | 7% | 7% |
| diethyleneglycol | 5% | 5% |
| Surfynol 465 | 1% | 1% |
| glycerin | 7% | 7% |
| Water | 76% | 76% |

TABLE 5

| | Amount | | Wt fraction | |
|---|---|---|---|---|
| | Base 1-2 | Base 2-2 | First pigment | Second pigment |
| Ex 2A | 84.2 | 27.1 | 0.756 | 0.244 |
| Ex 2B | 73.7 | 40.7 | 0.644 | 0.356 |
| Ex 2C | 52.6 | 67.8 | 0.437 | 0.563 |

Total pigment loading in each inkjet ink composition was 4%. In Table 5, the weight fraction is shown, which is the ratio of the specified pigment to the total amount of pigment in the inkjet ink composition. Thus, if the amount of the first modified pigment is X and the amount of the second modified pigment is Y, the weight fraction of the first modified pigment is X/(X+Y).

The inkjet ink compositions of the present invention (Examples 2A, 2B, and 2C) as well as the base compositions from which they were prepared (Base 1-2 and 2-2) were printed using a Canon i550 printer onto Canon PP-101 photoglossy paper, as described in Example 1, and print performance properties were determined from the resulting printed images after allowing 15 minutes for drying as described above. Results are shown in Table 6 below.

TABLE 6

Wt fraction

| | First pigment | Second pigment | DOI | WF |
|---|---|---|---|---|
| Base 1-2 | 1 | 0 | 1.8 | fail |
| Ex 2A | 0.756 | 0.244 | 1.9 | pass |
| Ex 2B | 0.644 | 0.356 | 1.7 | pass |
| Ex 2C | 0.437 | 0.563 | 1.4 | pass |
| Base 2-2 | 0 | 1 | 1.4 | pass |

As the data shows, the inkjet ink compositions of the present invention have performance properties that would not have been expected based on the performance of the base compositions from which they were prepared. For example, the DOI for Base 1-2 is 1.8 while that of Example 2A is 1.9. Thus, an increase in DOI is observed, even though the inkjet ink composition of Example 2A has less of the high DOI pigment (from Base 1-2) than Base 1-2 itself and even though 24.4% of the total pigment is a lower DOI pigment (from Base 2-2). Furthermore, the inkjet ink compositions of Examples 2A, 2B, and 2C have been found to have DOI values greater than what would be expected based on the weighted average of the DOI values for Base1-2 and Base 2-2 individually. In addition, each of Example 2A-2C have improved waterfastness properties compared to Base 1-2, even though as much as 75.6% of the total pigment is pigment from Base 1-2, which has poorer waterfastness.

Therefore, the inkjet ink compositions of the present invention, comprising two different modified pigments, have surprisingly been found to have a balance of good print performance properties, and this combination of properties would not be expected based on the performance of base compositions comprising either modified pigment individually, based on the weighted average.

### Comparative Example 1

The following example describes the preparation and print performance properties of comparative inkjet ink compositions comprising a first modified pigment and a second modified pigment, wherein the first modified pigment comprises a pigment having attached at least one non-polymeric group comprising a carboxylic acid group or salt thereof and the second modified pigment comprises a pigment having attached at least one polymeric group that does not comprise a carboxylic acid group or salt thereof.

For this example, the aqueous dispersion of a modified carbon black comprising a carbon black having attached benzoic acid groups (the first modified pigment) of Example 1 was used. Also, a dispersion of a modified carbon black comprising a carbon black having attached benzoic acid groups or salts thereof and an alkylene oxide polymer (the second modified pigment) was prepared by reacting Black Pearls® 1100 carbon black with 4-aminophenyl-2-sulfatoethylsulfone (APSES, 0.25 mmoles per gram of carbon black) and sodium nitrite (equimolar to APSES) to form a carbon black having attached sulfoethylsulfonate groups which was then reacted p-aminobenzoic acid (1.25 mmoles per gram of carbon black) and sodium nitrite (equimolar to p-aminobenzoic acid) followed by reaction with Jeffamine M2070 (available from Huntsman having an average molecular weight of 2,000, 0.5 mmoles of amine per gram of carbon black).

Inkjet ink compositions were prepared by combining a base composition comprising the dispersion of the first modified pigment (Comparative Base 1-1) and a base composition comprising the dispersion of the second modified pigment (Comparative Base 2-1) in varying ratios. The two base compositions are shown in Table 7 below, and the amounts of each base composition used to prepare the comparative inkjet ink compositions are shown in Table 8 below.

TABLE 7

| | Comp Base 1-2 | Comp Base 2-2 |
|---|---|---|
| First modified pigment | 4% | — |
| Second modified pigment | — | 4% |
| trimethylolpropane | 7% | 7% |
| diethyleneglycol | 5% | 5% |
| Surfynol 465 | 1% | 1% |
| glycerin | 7% | 7% |
| Water | 76% | 76% |

TABLE 8

| | Amount | | Wt fraction | |
|---|---|---|---|---|
| | Comp | | | Second |
| | Base 1-1 | Comp Base 2-1 | First pigment | pigment |
| Comp Ex 1A | 84.2 | 24.0 | 0.779 | 0.221 |
| Comp Ex 1B | 73.7 | 35.9 | 0.672 | 0.328 |
| Comp Ex 1C | 52.6 | 59.9 | 0.468 | 0.532 |

Total pigment loading in each inkjet ink composition was 4%. In Table 8, the weight fraction is shown, which is the ratio of the specified pigment to the total amount of pigment in the inkjet ink composition. Thus, if the amount of the first modified pigment is X and the amount of the second modified pigment is Y, the weight fraction of the first modified pigment is X/(X+Y).

The comparative inkjet ink compositions (Comparative Examples 1A, 1B, and 1C) as well as the base compositions from which they were prepared (Comparative Base 1-1 and 2-1) were printed using a Canon i550 printer onto Canon PP-101 photoglossy paper, as described in Example 1, and print performance properties were determined from the resulting printed images after allowing 15 minutes for drying as described above. Results are shown in Table 9 below.

TABLE 9

| | Wt fraction | | | | | |
|---|---|---|---|---|---|---|
| | First | Second | | | | |
| | pigment | pigment | Gloss | DOI | Wet Smear | WF |
| Comp Base 1-1 | 1 | 0 | 153 | 3.7 | fail | fail |
| Comp Ex 1A | 0.779 | 0.221 | 162.5 | 3.6 | fail | fail |
| Comp Ex 1B | 0.672 | 0.328 | 164 | 3.6 | fail | fail |
| Comp Ex 1C | 0.468 | 0.532 | 163 | 3.6 | fail | fail |
| Comp Base 2-1 | 0 | 1 | 144 | 3.1 | fail | fail |

As the data shows, while the comparative inkjet ink compositions have gloss and DOI values that are improved based on the performance of the comparative base compositions from which they were prepared, these compositions do not have improved durability. Each of the comparative inkjet ink compositions had poor wet smear and waterfastness properties. Therefore, the comparative inkjet ink compositions, which comprise two modified pigments in which the second modified pigment does not comprise a pigment having attached at least one polymeric group comprising a carboxylic acid or salt thereof, do not have a balance of print performance properties compared to the inkjet ink compositions of the present invention, comprising the same first modified pigment with a second modified pigment comprising a pigment having attached at least one polymeric group comprising a carboxylic acid or salt thereof.

The foregoing description of preferred embodiments of the present invention has been presented for the purposes of illustration and description. It is not intended to be exhaustive or to limit the invention to the precise form disclosed. Modifications and variations are possible in light of the above teachings, or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. An inkjet ink composition comprising a) a liquid vehicle; b) at least one first modified pigment; and c) at least one second modified pigment, wherein
the first modified pigment comprises a first pigment having attached at least one non-polymeric group and is present in an amount X;
the second modified pigment comprises a second pigment having attached at least one polymeric group and is present in an amount Y; and
X/(X+Y)>0.5.

2. The inkjet ink composition of claim 1, wherein X/(X+Y) is from about 0.55 to about 0.90.

3. The inkjet ink composition of claim 1, wherein X/(X+Y) is from about 0.6 to about 0.8.

4. The inkjet ink composition of claim 1, wherein the non-polymeric group comprises at least one ionic group, at least one ionizable group, or a mixture thereof.

5. The inkjet ink composition of claim 1, wherein the non-polymeric group comprises at least one carboxylic acid group or salt thereof.

6. The inkjet ink composition of claim 1, wherein the non-polymeric group is a group having the formula —X—(CO₂)ₙ⁻M⁺, wherein X, which is attached to the pigment, is an arylene, heteroarylene, alkylene, alkarylene, or aralkylene group; M⁺ is H⁺, Na⁺, K⁺, Li⁺, or NR₄⁺, wherein R, which can be the same or different, represents hydrogen or an organic group such as a substituted or unsubstituted aryl and/or alkyl group; and n is 1 to 4.

7. The inkjet ink composition of claim 6, wherein X is an arylene group.

8. The inkjet ink composition of claim 6, wherein the non-polymeric group is a —C₆H₄—CO₂⁻M⁺ group.

9. The inkjet ink composition of claim 1, wherein the polymeric group comprises at least one anionic group, at least one anionizable group, or a mixture thereof.

10. The inkjet ink composition of claim 1, wherein the polymeric group comprises at least one carboxylic acid group or salt thereof.

11. The inkjet ink composition of claim 10, wherein the polymeric group is an acrylate or methacrylate polymeric group or a maleic acid or maleic anhydride polymeric group.

12. The inkjet ink composition of claim 10, wherein the polymeric group is a styrene-acrylic acid, a styrene-methacrylic acid, or a styrene-maleic acid polymeric group.

13. The inkjet ink composition of claim 1, wherein the first pigment or the second pigment has a DBP value of less than or equal to 100 mL/100 g pigment.

14. The inkjet ink composition of claim 1, wherein the first pigment or the second pigment has a DBP value of less than or equal to 80 mL/100 g pigment.

15. The inkjet ink composition of claim 1, wherein the first pigment or the second pigment has a DBP value of less than or equal to 70 mL/100 g pigment.

16. The inkjet ink composition of claim 13, wherein the first pigment or the second pigment has a BET surface area value of greater than or equal to 200 m²/g.

17. The inkjet ink composition of claim 13, wherein the first pigment or the second pigment has a BET surface area value of greater than or equal to 230 m²/g.

18. The inkjet ink composition of claim 1, wherein the first pigment and the second pigment are carbon black.

19. The inkjet ink composition of claim 1, wherein the first pigment and the second pigment are the same.

20. An inkjet ink composition comprising a) a liquid vehicle; b) at least one first modified pigment; and c) at least one second modified pigment, wherein
the first modified pigment comprises a first pigment having attached at least one non-polymeric group comprising a carboxylic acid group or salt thereof; and
the second modified pigment comprises a second pigment having attached at least one polymeric group comprising a carboxylic acid group or salt thereof.

21. The inkjet ink composition of claim 20, wherein the non-polymeric group is a group having the formula —X—(CO₂)ₙ⁻M⁺, wherein X, which is attached to the pigment, is an arylene, heteroarylene, alkylene, alkarylene, or aralkylene group; M⁺ is H⁺, Na⁺, K⁺, Li⁺, or NR₄⁺, wherein R, which can be the same or different, represents hydrogen or an organic group such as a substituted or unsubstituted aryl and/or alkyl group; and n is 1 to 4.

22. The inkjet ink composition of claim 21, wherein X is an arylene group.

23. The inkjet ink composition of claim 21, wherein the non-polymeric group is a —C₆H₄—CO₂⁻M⁺ group.

24. The inkjet ink composition of claim 20, wherein the polymeric group is an acrylate or methacrylate polymeric group or a maleic acid or maleic anhydride polymeric group.

25. The inkjet ink composition of claim 20, wherein the polymeric group is a styrene-acrylic acid, a styrene-methacrylic acid, or a styrene-maleic acid polymeric group.

26. The inkjet ink composition of claim 20, wherein the first pigment or the second pigment has a DBP value of less than or equal to 100 mL/100 g pigment.

27. The inkjet ink composition of claim 20, wherein the first pigment or the second pigment has a DBP value of less than or equal to 80 mL/100 g pigment.

28. The inkjet ink composition of claim 20, wherein the first pigment or the second pigment has a DBP value of less than or equal to 70 mL/100 g pigment.

29. The inkjet ink composition of claim 26, wherein the first pigment or the second pigment has a BET surface area value of greater than or equal to 200 m²/g.

30. The inkjet ink composition of claim 26, wherein the first pigment or the second pigment has a BET surface area value of greater than or equal to 230 m²/g.

31. The inkjet ink composition of claim 20, wherein the first pigment and the second pigment are carbon black.

32. The inkjet ink composition of claim 20, wherein the first pigment and the second pigment are the same.

33. A dispersion comprising a) a liquid vehicle; b) at least one first modified pigment; and c) at least one second modified pigment, wherein
the first modified pigment comprises a first pigment having attached at least one non-polymeric group and is present in an amount X;
the second modified pigment comprises a second pigment having attached at least one polymeric group and is present in an amount Y; and
X/(X+Y)>0.5.

34. A dispersion comprising a) a liquid vehicle; b) at least one first modified pigment; and c) at least one second modified pigment, wherein
the first modified pigment comprises a first pigment having attached at least one non-polymeric group comprising a carboxylic acid group or salt thereof; and
the second modified pigment comprises a second pigment having attached at least one polymeric group comprising a carboxylic acid group or salt thereof.
